(19) United States
(12) Patent Application Publication
(10) Pub. No.: US 2017/0086461 A1
(43) Pub. Date: Mar. 30, 2017

(54) SYNERGISTIC ANTIMICROBIAL COMPOSITION

(71) Applicant: Dow Global Technologies LLC, Midland, MI (US)

(72) Inventors: Patrick T. Felder, Grabs (CH); Maciej Szymeczko, Horgen (CH); Alessandro Vezzoli, Horgen (CH); Emmanuelle Christine Yvon, Oberrieden (CH)

(21) Appl. No.: 15/277,485

(22) Filed: Sep. 27, 2016

(30) Foreign Application Priority Data
Sep. 30, 2015 (US) 62/234827

(51) Int. Cl. A01N 43/80; A01N 31/08

(52) U.S. Cl. CPC A01N 43/80; A01N 31/08

(57) ABSTRACT

A synergistic antimicrobial composition comprising 2-methyl-1,2-benzothiazol-3(2H)-one and (b) 4-chloro-3-methylphenol.

This invention relates to combinations of biocides, the combinations having greater activity than would be observed for the individual antimicrobial compounds.

Use of combinations of at least two antimicrobial compounds can broaden potential markets, reduce use concentrations and costs, and reduce waste. In some cases, commercial antimicrobial compounds cannot provide effective control of microorganisms, even at high use concentrations, due to weak activity against certain types of microorganisms, or relatively slow antimicrobial action, or instability under certain conditions such as high temperature and high pH. Combinations of different antimicrobial compounds are sometimes used to provide overall control of microorganisms or to provide the same level of microbial control at lower use rates in a particular end use environment. Additionally, synergy has been found to be an unpredictable phenomenon. Often like compounds display varying synergistic profiles when combined with a particular active. It may be that no synergy is evidenced or it may be that synergy exists but over a different synergistic range. Because of this observation, it is difficult, if not impossible, to draw conclusions regarding the synergistic profile of one compound based upon the synergistic profile of a like compound. Thus more synergistic combinations and their synergistic ranges must be discovered.

One such example of synergy is found in U.S. Pat. App. Pub. No. 2007/0078118. This reference discloses synergistic combinations of N-methyl-1,2-benzisothiazolin-3-one (MBIT) with other biocides. There still exists a need for additional combinations of antimicrobial compounds having enhanced activity to provide effective control of microorganisms. The problem addressed by this invention is to provide such combinations of antimicrobial compounds.

### STATEMENT OF THE INVENTION

The present invention is directed to a synergistic antimicrobial composition comprising: (a) 2-methyl-1,2-benzothiazol-3(2H)-one and (b) 4-chloro-3-methylphenol.

### DETAILED DESCRIPTION OF THE INVENTION

As used herein, the following terms have the designated definitions, unless the context clearly indicates otherwise. The term “antimicrobial compound” refers to a compound capable of inhibiting the growth or propagation of microorganisms, and/or killing microorganisms; antimicrobial compounds include biocides, bactericides, bacteriostats, fungicides, fungistats, algaecides and algistats, depending on the dose level applied, system conditions and the level of microbial control desired. The term “microorganism” includes, for example, fungi (such as yeast and mold), bacteria, algae and archaea. The following abbreviations are used throughout the specification: ppm=parts per million by weight (weight/weight), mL=milliliter. Unless otherwise specified, temperatures are in degrees centigrade (° C.), and references to percentages are by weight (wt. %). Percentages of antimicrobial compounds in the composition of this invention are based on the total weight of active ingredients in the composition, i.e., the antimicrobial compounds themselves, exclusive of any amounts of solvents, carriers, dispersants, stabilizers or other materials which may be present. Lastly, all range value endpoints are inclusive and combinable (e.g. Ranges expressed as from 10:1 to 1:10 and alternatively 3:1 and 1:3 may also include, for example 10:3).

As used herein, 2-methyl-1,2-benzothiazol-3(2H)-one or “MBIT” corresponds with CAS #: 2527-66-4.

As used herein, 4-chloro-3-methylphenol or “chlorocresol” corresponds with CAS #: 59-50-7.

In some embodiments of the invention, a weight ratio of the 2-methyl-1,2-benzothiazol-3(2H)-one to 4-chloro-3-methylphenol is from 1:10 to 1:0.50, alternatively from 1:7 to 1:0.50, and further alternatively from 1:6.67 to 1:0.67.

In some embodiments of the invention, the antimicrobial combination of this invention is useful for inhibiting microbial growth in a medium for example as an in-can preservative. The composition also is useful for controlling microorganisms in other industrial water and water containing/contaminated media, such as cooling water, air washer, heat exchangers, boiler water, pulp and paper mill water, other industrial process water media such as: ballast water, wastewater, metalworking fluids, oil and gas production fluids, latex emulsions, water-based paints and coatings, adhesives, inks, tape joint compounds, pigments, water-based slurries, personal care products, household products such as laundry products and hard surface cleaners, filtration systems (including reverse osmosis and ultrafiltration systems), textile and leather chemicals and processes, or a system used therewith.

Typically, the amount of the biocide combinations of the present invention to control the growth of microorganisms is from 10 ppm to 5,000 ppm active ingredient. In some embodiments of the invention, the active ingredients of the composition are present in an amount of at least 20 ppm, alternatively at least 50 ppm, alternatively at least 100 ppm, alternatively at least 150 ppm, alternatively at least 200 ppm. In some embodiments, the active ingredients of the composition are present in an amount of no more than 2,000 ppm, alternatively no more than 1,000 ppm, alternatively no more than 500 ppm, alternatively no more than 400 ppm, alternatively no more than 300 ppm, alternatively no more than 250 ppm, alternatively no more than 200 ppm, alternatively no more than 100 ppm, alternatively no more than 50 ppm. Concentrations mentioned above are in a liquid composition containing the biocide combinations.

The present invention also encompasses a method for reducing, or inhibiting, or preventing microbial growth in the use areas described above, especially in the preservation of water-based products and systems, by incorporating the claimed biocide combination into the materials.

### EXAMPLES

The synergism of the biocides combination of the present invention was determined using the method described by Kull, F.C., et. al in Applied Microbiology 9:538-541 (1961).

The formula to calculate the synergy index (SI) is

Qa/QA+Qb/QB=SI

### Where

QA=concentration of compound A in ppm, acting alone produced an end point (growth/no growth)
Qa=concentration of compound A in ppm, in the mixture, which produced an end point (growth/no growth)
QB=concentration of compound B in ppm, acting alone produced an end point (growth/no growth)
Qb=concentration of compound B in ppm, in the mixture, which produced an end point (growth/no growth)

Synergism within two biocides is demonstrated when the SI has a value less than 1. The mixtures showed an additive effect if SI is equal to 1 and antagonistic if SI is greater than 1.

The Minimum Inhibitory Test (MIC) is designed to evaluate the lowest concentration of a biocide, biocide blend or biocide combination to prevent bacteria growing in a defined broth.

Minimum Inhibitory Concentration (MIC) Testing Protocol
1. Concentrated solutions in water of the selected biocides were used to prepare biocide combinations in 3 different ratios (1:6.67; 1:67.4; 1:0.67). From each single biocide and each combination, sixteen serial dilutions with a dilution factor of 1.3 were then prepared. Test samples were prepared in equal volume by adding 20 μl of each biocide dilution prepared in the previous step to 170 μl TSB resulting in a total volume of 190 μl. All single biocide concentrations and combinations were tested against Pseudomonas aeruginosa. As a negative control, four samples containing no biocide were included.
2. Preparation of the microbe suspension:

### Bacterial Cultures:

| | | | |
|---|---|---|---|
| Pseudomonas aeruginosa | DSM # 939 | ATCC# | 15442 |

The culture was maintained as a glycerol stock at −80° C. in cryovials. A cryovial was thawed and then 100 μl spread on a TSA agar plate. After incubation for 1 day at 30° C. the bacteria were harvested with buffer at pH 7.3. A total viable count on TSA plate was carried out and bacterial suspension was diluted in buffer in order to deliver ˜2×10⁷ CFU/ml.
3. Each test sample (190 μl) was inoculated with the 10 μl of microbe suspension to provide a level of ˜1×10⁶ CFU/ml of the bacteria species.
4. The test samples were mixed and incubated at 30° C. for 2 days (48 hours).
5. Growth of the micro-organisms leads to turbidity after incubation, clarity indicates no growth. Reading of the results was carried out by measuring absorbance at 600 nm for each sample at the beginning of the test (t_{zero}) and after incubation (t_{endpoint}). t_{endpoint} was chosen at 48 hours for bacteria. The difference in absorbance between t_{endpoint} and t_{zero} was used to assign a score (Δ>0.2 confirms growth while Δ≦0.2 confirms no growth) from which the MIC values were calculated. The lowest concentration that showed no growth in the broth after incubation is taken as the MIC value.

The results of combination of two biocides exhibiting synergy against the bacteria are presented in Table 1.

TABLE 1
Biocidal efficacy and synergy of Chlorocresol and MBIT
against Pseudomonas aeruginosa DSM # 939

| | Minimum | | |
|---|---|---|---|
| | Concentration (active | | |
| Active weight ratio of | ppm) to Inhibit Growth | | Synergy |
| MBIT:Chlorocresol | MBIT | Chlorocresol | Index |
| Actives alone | 62 | 1539 | |
| 1:67.4 | 21 | 1400 | 1.25 |
| 1:6.67 | 40 | 269 | 0.82 |
| 1:0.67 | 44 | 29 | 0.73 |

1. A synergistic antimicrobial composition comprising: (a) 2-methyl-1,2-benzothiazol-3(2H)-one and (b) 4-chloro-3-methylphenol.

2. The synergistic antimicrobial composition of claim 1 wherein a weight ratio of the 2-methyl-1,2-benzothiazol-3(2H)-one to 4-chloro-3-methylphenol is from 1:10 to 1:0.50.

3. A method of inhibiting the growth of or controlling the growth of microorganisms in a water-based product the method comprising the step of adding the synergistic antimicrobial composition of claim 1 to the water-based product.

4. A water-based product composition comprising the synergistic antimicrobial composition of claim 1.

5. A water-based product composition comprising the synergistic antimicrobial composition of claim 2.
